(19) United States
(12) Patent Application Publication
(10) Pub. No.: US 2022/0358218 A1
(43) Pub. Date: Nov. 10, 2022

(54) POLLUTED RANGE LOCATING APPARATUS AND COMPUTER READABLE MEDIUM

(71) Applicant: MITSUBISHI ELECTRIC CORPORATION, Tokyo (JP)

(72) Inventor: Yuta ATOBE, Tokyo (JP)

(73) Assignee: MITSUBISHI ELECTRIC CORPORATION, Tokyo (JP)

(21) Appl. No.: 17/874,716

(22) Filed: Jul. 27, 2022

Related U.S. Application Data
(63) Continuation of application No. PCT/JP2020/012365, filed on Mar. 19, 2020.

(51) Int. Cl. G06F 21/56

(52) U.S. Cl. CPC G06F 21/566; G06F 2221/033

(57) ABSTRACT

A relationship building unit (120), based on a plurality of pieces of software operation data, each of which includes an operation type of software operation and operation object information that indicates a plurality of software objects used in the software operation, generates object relationship data that indicates a relationship between the plurality of software objects. A polluted range locating unit (130), based on the object relationship data and alert data that notifies occurrence of a cyberattack, generates polluted range data that indicates a polluted range affected by the cyberattack.

### CROSS REFERENCE TO RELATED APPLICATIONS

This application is a Continuation of PCT International Application PCT/JP2020/012365, filed on Mar. 19, 2020, which is hereby expressly incorporated by reference into the present application.

### TECHNICAL FIELD

The present disclosure relates to recurrence prevention of pollution caused by a cyberattack.

### BACKGROUND ART

A measure such as the following is taken against a cyberattack.

First, a cyberattack on a monitoring target is detected.

Next, effects of the cyberattack are determined.

Then, degraded operation of the monitoring target is decided on according to the effects of the cyberattack. For example, in the degraded operation, switching of functions or repositioning of functions is performed.

Removal of a polluted part and action for recurrence prevention are necessary to be carried out for the effects of the cyberattack.

The removal of the polluted part means deletion, restoration, initialization, and the like of the polluted part. The polluted part is a part that is altered by the cyberattack. For example, the polluted part is a code that is altered or data that is altered. The polluted part is necessary to be located for the removal of the polluted part.

Since there is a risk of the monitoring target coming under cyberattack again with only the polluted part being removed, taking action for the recurrence prevention is necessary. Specific action for the recurrence prevention is to cut off an intrusion route of the cyberattack. The intrusion route of the cyberattack is necessary to be located to cut off the intrusion route of the cyberattack.

Patent Literature 1 discloses technology for maintaining traveling control of an automobile in a safe state even in a case where an abnormality arising from a security attack occurred in an in-vehicle system.

### CITATION LIST

### Patent Literature

Patent Literature 1: JP 2018-194909 A

### SUMMARY OF INVENTION

### Technical Problem

The degraded operation being uniquely decided on based on content of an abnormality and a place of the abnormality is disclosed in Patent Literature 1. A method to remove the polluted part and to take action for the recurrence prevention, however, is not disclosed. Especially, a method to locate the intrusion route and a method to locate the polluted part are not disclosed.

The present disclosure aims to make an intrusion route and a polluted part locatable.

### Solution to Problem

A polluted range locating apparatus of the present disclosure includes:

a relationship building unit, based on a plurality of pieces of software operation data, each of which includes an operation type of software operation and operation object information that indicates a plurality of software objects used in the software operation, to generate object relationship data that indicates a relationship between the plurality of software objects; and

a polluted range locating unit, based on the object relationship data and alert data that notifies occurrence of a cyberattack, to generate polluted range data that indicates a polluted range affected by the cyberattack.

### Advantageous Effects of Invention

According to the present disclosure, locating a polluted range such as an intrusion route and a polluted part will be possible.

### BRIEF DESCRIPTION OF DRAWINGS

FIG. 1 is a configuration diagram of a polluted range locating apparatus 100 according to Embodiment 1.

FIG. 2 is a flowchart of a polluted range locating method according to Embodiment 1.

FIG. 3 is a diagram illustrating object relationship data 191 according to Embodiment 1.

FIG. 4 is a diagram illustrating intrusion route data 192 according to Embodiment 1.

FIG. 5 is a diagram illustrating polluted object data 193 according to Embodiment 1.

FIG. 6 is a flowchart of relationship building (S110) according to Embodiment 1.

FIG. 7 is a flowchart of polluted range locating (S120) according to Embodiment 1.

FIG. 8 is a diagram illustrating object relationship data 194 according to Embodiment 2.

FIG. 9 is a diagram illustrating object relationship data 195A according to Embodiment 3.

FIG. 10 is a diagram illustrating object relationship data 195D according to Embodiment 3.

FIG. 11 is a diagram illustrating object relationship data 195G according to Embodiment 3.

FIG. 12 is a hardware configuration diagram of a polluted range locating apparatus 100 according to Embodiments.

### DESCRIPTION OF EMBODIMENTS

In the embodiments and in the drawings, the same reference signs are added to the same elements or corresponding elements. Description of elements having the same reference signs added as the elements described will be suitably omitted or simplified. Arrows in the drawings mainly indicate flows of data or flows of processes.

### Embodiment 1

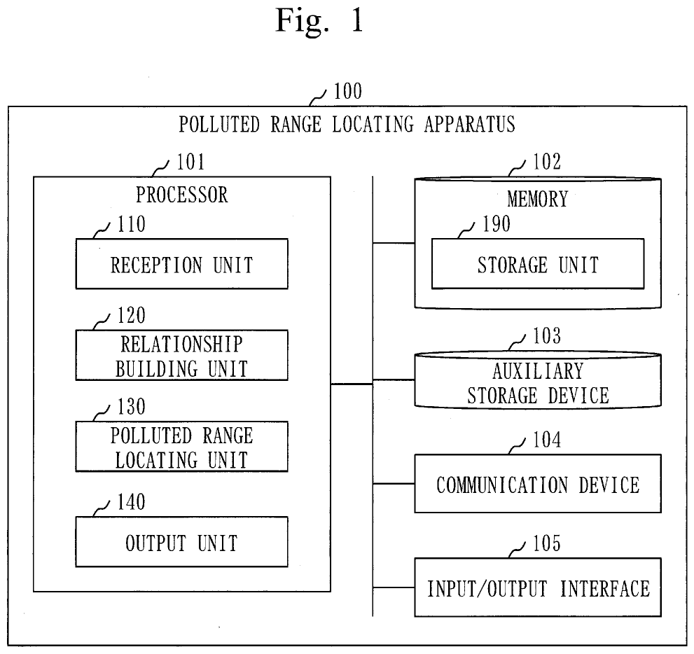

A polluted range locating apparatus 100 will be described based on FIG. 1 to FIG. 7.

Description of Configuration

A configuration of the polluted range locating apparatus 100 will be described based on FIG. 1.

The polluted range locating apparatus 100 is a computer that includes hardware such as a processor 101, a memory 102, an auxiliary storage device 103, a communication device 104, and an input/output interface 105. These hardware are connected to each other by signal lines.

The processor 101 is an IC that performs a calculation process and controls other hardware. For example, the processor 101 is a CPU, a DSP, or a GPU.

IC is an abbreviated name for Integrated Circuit.

CPU is an abbreviated name for Central Processing Unit.

DSP is an abbreviated name for Digital Signal Processor.

GPU is an abbreviated name for Graphics Processing Unit.

The memory 102 is a volatile or a non-volatile storage device. The memory 102 is also called a main storage device or a main memory. For example, the memory 102 is a RAM. Data stored in the memory 102 is saved in the auxiliary storage device 103 as necessary.

RAM is an abbreviated name for Random Access Memory.

The auxiliary storage device 103 is a non-volatile storage device. For example, the auxiliary storage device 103 is a ROM, an HDD, or a flash memory. Data stored in the auxiliary storage device 103 is loaded into the memory 102 as necessary.

ROM is an abbreviated name for Read Only Memory.

HDD is an abbreviated name for Hard Disk Drive.

The communication device 104 is a receiver and a transmitter. For example, the communication device 104 is a communication chip or an NIC.

NIC is an abbreviated name for Network Interface Card.

The input/output interface 105 is a port to which an input device and an output device are connected. For example, the input/output interface 105 is a USB terminal, the input device is a keyboard and a mouse, and the output device is a display.

USB is an abbreviated name for Universal Serial Bus.

The polluted range locating apparatus 100 includes elements such as a reception unit 110, a relationship building unit 120, a polluted range locating unit 130, and an output unit 140. These elements are realized by software.

A polluted range locating program that causes a computer to function as the reception unit 110, the relationship building unit 120, the polluted range locating unit 130, and the output unit 140 is stored in the auxiliary storage device 103. The polluted range locating program is loaded into the memory 102 and executed by the processor 101.

An OS is, furthermore, stored in the auxiliary storage device 103. At least a part of the OS is loaded into the memory 102 and executed by the processor 101.

The processor 101 executes the polluted range locating program while executing the OS.

OS is an abbreviated name for Operating System.

Inputted/outputted data of the polluted range locating program is stored in a storage unit 190.

The memory 102 functions as the storage unit 190. A storage device such as the auxiliary storage device 103, a register in the processor 101, a cache memory in the processor 101, and the like, however, may function as the storage unit 190 instead of the memory 102 or with the memory 102.

The polluted range locating apparatus 100 may include a plurality of processors that replace the processor 101. The plurality of processors share functions of the processor 101.

The polluted range locating program can be computer-readably recorded (stored) in a non-volatile recording medium such as an optical disc, the flash memory, or the like.

Description of Operation A procedure of operation of the polluted range locating apparatus 100 is equivalent to a polluted range locating method. The procedure of the operation of the polluted range locating apparatus 100 is equivalent to a procedure of a process by the polluted range locating program.

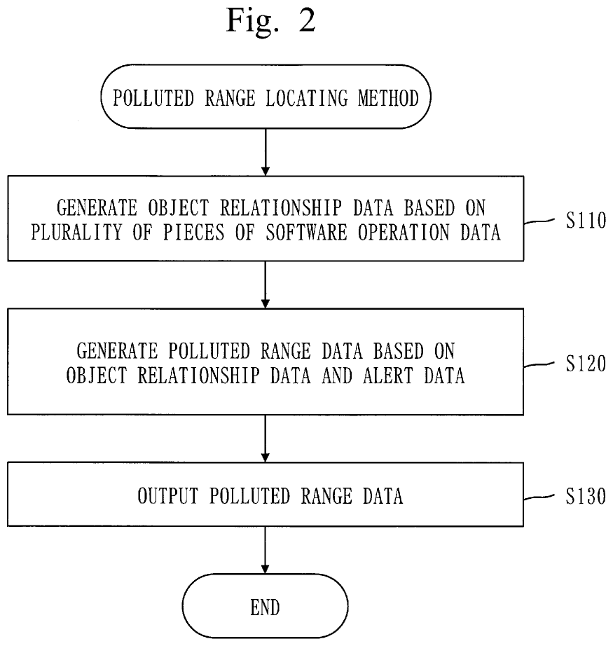

The polluted range locating method will be described based on FIG. 2.

In step S110, the relationship building unit 120 generates object relationship data based on a plurality of pieces of software operation data.

The software operation data is data that indicates software operation.

The software operation is operation that occurred by execution of software. Examples of the software operation are shown below.

(1) Process Start.

(2) Process End.

(3) Communication.

(4) Write File.

(5) Read File.

(6) Change File Permission.

(7) System Call.

(8) Application Operation.

(9) Authentication (Success).

(10) Authentication (Failure).

(11) Policy Violation.

Specific examples of the software operation data are log data such as a communication log, an OS log, a file manipulation log, an application log, a memory manipulation log, or the like. The log data, for example, is outputted from an OS or an application.

The software operation data includes an operation type, operation object information, and operation time.

The operation type is a type of software operation.

The operation object information indicates a plurality of software objects that have been used in the software operation.

The software object is an element used at execution of software. Examples of the software object are shown below.

(1) A file such as a data file, a program file, or the like.

(2) Each piece of data in a data file. Each piece of data is used in a process.

(3) A process. The process is each instance after a program file has been executed.

Specifically, the operation object information indicates an operation object and a target object.

The operation object is a software object that performs the software operation. That is, the operation object is a software object that is to be a subject of the software operation. A specific example of the operation object is a process.

The target object is a software object that is to be a target of the software operation. That is, the target object is a software object that is to be an object of the software operation. A specific example of the target object is a file.

The operation time is time that the software operation occurred.

The object relationship data is data that indicates a relationship between the plurality of software objects. Specifically, the object relationship data represents an object relationship graph.

The object relationship graph has a node for every software object and an edge for every set of nodes.

The node represents a software object.

The edge represents a relationship between the software objects.

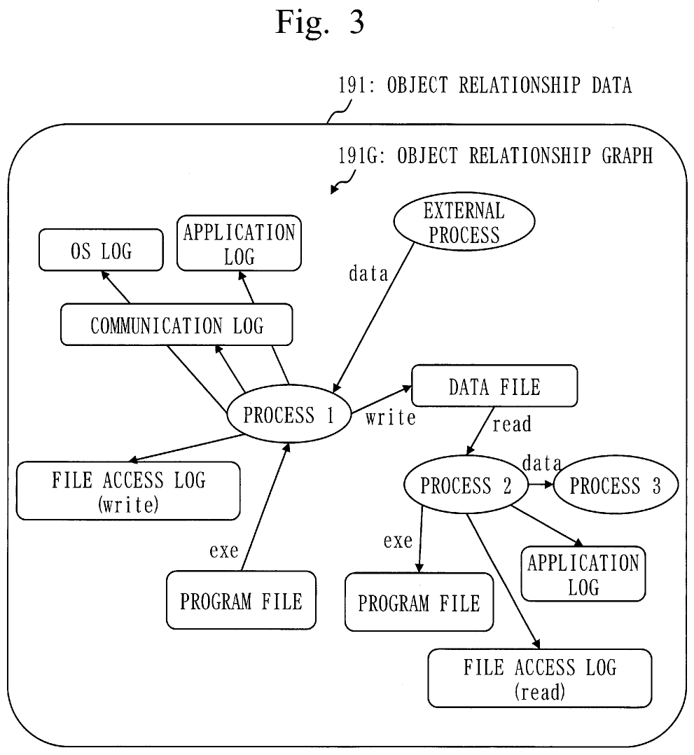

Object relationship data 191 is illustrated in FIG. 3. The object relationship data 191 is an example of the object relationship data.

The object relationship data 191 represents an object relationship graph 191G.

In the object relationship graph 191G, an element on which a process name, a file name, or a log name is written is the node. A line that links the nodes is the edge. An edge represented by an arrowed line is a directed edge that represents a directed relationship according to the operation type. A term added to the edge indicates a relationship according to the operation type.

Returning to FIG. 2, the description will continue.

A procedure of relationship building (S110) will be described later.

In step S120, the polluted range locating unit 130 generates polluted range data based on the object relationship data and alert data.

The alert data is data that notifies occurrence of a cyberattack, and includes abnormal object information.

The abnormal object information indicates an abnormal object.

The abnormal object is a software object where the cyberattack was detected.

The polluted range data is data that indicates a polluted range, and includes intrusion route data and polluted object data. The polluted range is a range affected by the cyberattack.

The intrusion route data indicates an intrusion route of the cyberattack. The intrusion route of the cyberattack is included in the polluted range.

The polluted object data indicates a polluted object.

The polluted object is a software object affected by the cyberattack.

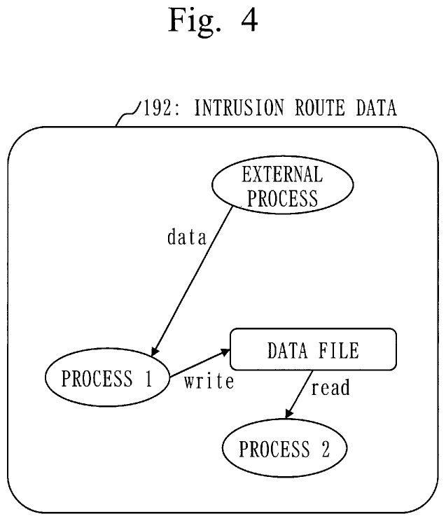

Intrusion route data 192 is illustrated in FIG. 4. The intrusion route data 192 is an example of the intrusion route data.

The intrusion route data 192 indicates an intrusion route from an external process to process 2. Process 2 is the abnormal object.

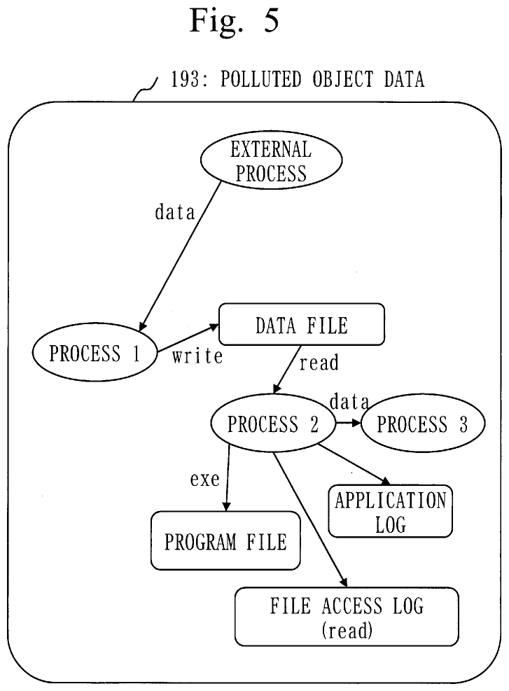

Polluted object data 193 is illustrated in FIG. 5. The polluted object data 193 is an example of the polluted object data.

The polluted object data 193 indicates, other than each software object on the intrusion route, each software object affected by process 2.

Returning to FIG. 2, the description will continue.

A procedure of polluted range locating (S120) will be described later.

In step S130, the output unit 140 outputs the polluted range data.

That is, the output unit 140 outputs the intrusion route data and the polluted object data.

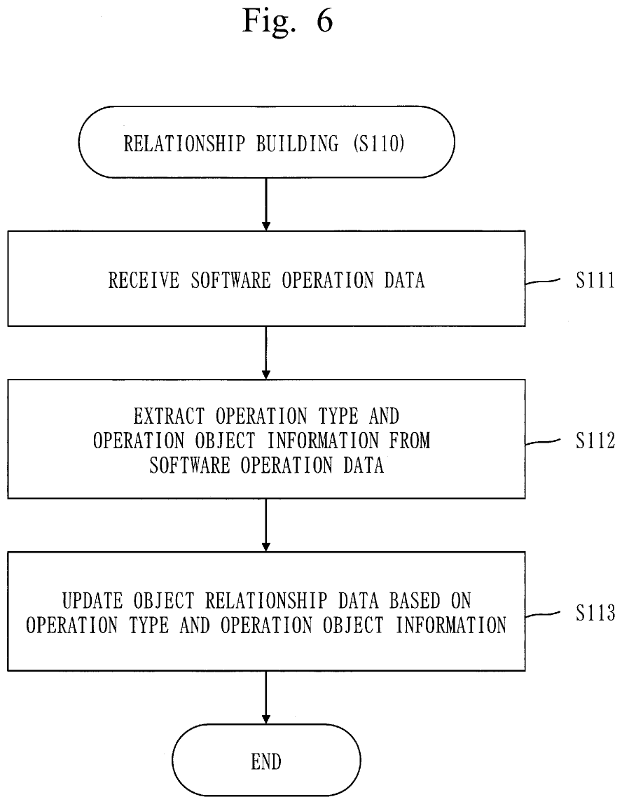

The procedure of the relationship building (S110) will be described based on FIG. 6.

Empty object relationship data is prepared beforehand.

Step S111 to step S113 are executed for each piece of software operation data.

In step S111, the reception unit 110 receives the software operation data.

Specifically, the software operation data is inputted to the polluted range locating apparatus 100. Then, the reception unit 110 receives the software operation data inputted and stores the software operation data inputted in the storage unit 190.

The software operation data may be inputted by a user, inputted by communication with a monitoring target, or inputted by other methods.

In step S112, the relationship building unit 120 extracts the operation type and the operation object information from the software operation data.

In step S113, the relationship building unit 120 updates the object relationship data based on the operation type and the operation object information.

The object relationship data is updated as follows. The object relationship data represents the object relationship graph. The operation object information indicates two software objects: the operation object and the target object.

The relationship building unit 120 searches the object relationship graph for a node that represents each software object indicated in the operation object information.

The relationship building unit 120 newly generates a node that is not found and adds the node that is generated to the object relationship graph.

The relationship building unit 120 selects an operation object node and a target object node from the object relationship graph. The operation object node is a node that represents the operation object, and the target object node is a node that represents the target object.

The relationship building unit 120 generates an edge that links the two nodes selected, and adds the edge generated to the object relationship graph. Specifically, the relationship building unit 120 specifies a directed relationship between the operation object and the target object according to the operation type, and adds a directed edge from the operation object node to the target object node. The directed edge has a direction that represents the directed relationship specified.

By the relationship building (S110) being executed for each of the plurality of pieces of software operation data, the object relationship data 191 (refer to FIG. 3) is generated, for example.

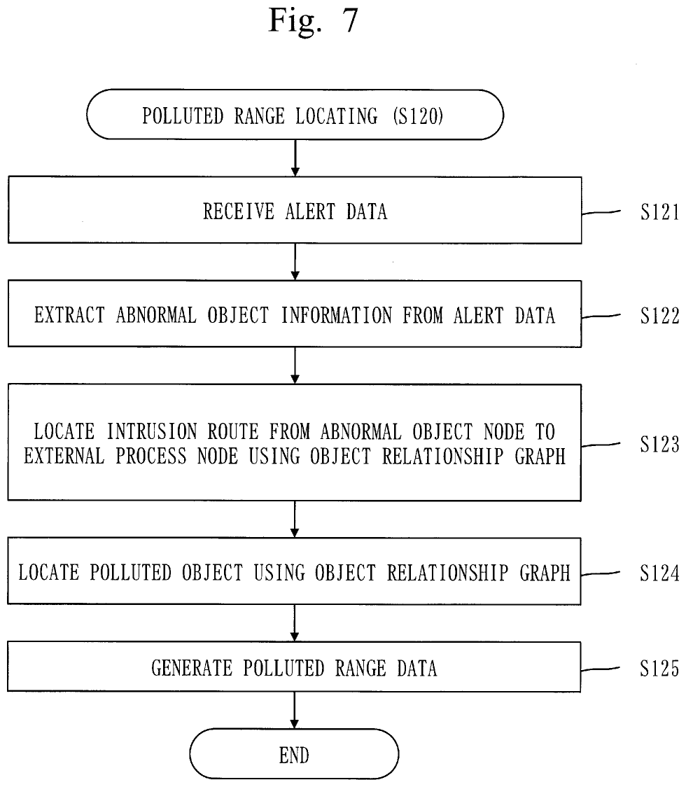

The procedure of the polluted range locating (S120) will be described based on FIG. 7.

In step S121, the reception unit 110 receives the alert data.

Specifically, the alert data is inputted to the polluted range locating apparatus 100. Then, the reception unit 110 receives the alert data inputted and stores the alert data inputted in the storage unit 190.

The alert data may be inputted by a user, inputted by communication with an attack detection device, or inputted by other methods. The attack detection device is a device that monitors the monitoring target, detects the cyberattack that has occurred, and outputs the alert data.

In step S122, the polluted range locating unit 130 extracts the abnormal object information from the alert data.

In step S123, the polluted range locating unit 130 locates an intrusion route from an abnormal object node to an external process node using the object relationship graph.

The intrusion route is located as follows. Each edge in the object relationship graph is a directed edge.

First, the polluted range locating unit 130 selects the abnormal object node from inside the object relationship graph. The abnormal object node is a node that represents the abnormal object.

Then, the polluted range locating unit 130 follows each directed edge from the abnormal object node to the external process node in a reverse direction. The external process node is a node that represents the external process. The external process is a process that is generated externally of the monitoring target.

A route from the abnormal object node to the external process node is the intrusion route.

In step S124, the polluted range locating unit 130 locates the polluted object using the object relationship graph.

The polluted object is located as follows.

The polluted range locating unit 130 selects, from the object relationship graph, each node positioned on the intrusion route. The software object represented by each node selected is the polluted object.

Furthermore, the polluted range locating unit 130 follows each directed edge from each node positioned on the intrusion route in a forward direction. The software object represented by each node at an end of each directed edge that is followed is the polluted object.

In step S125, the polluted range locating unit 130 generates the polluted range data.

That is, the polluted range locating unit 130 generates the intrusion route data and the polluted object data.

The intrusion route data is generated as follows.

The polluted range locating unit 130 generates data that indicates the intrusion route located in step S123. The data generated is the intrusion route data.

The polluted object data is generated as follows.

The polluted range locating unit 130 generates data that indicates the polluted object located in step S124. The data generated is the polluted object data.

The intrusion route data 192 (refer to FIG. 4) and the polluted object data 193 (refer to FIG. 5) are generated by the polluted range locating (S120) being executed using the object relationship data 191 (refer to FIG. 3). The abnormal object is process 2.

Description of Examples

Examples of the relationship building (S110) (refer to FIG. 6) are shown below.

### Example 1

In step S111, the reception unit 110 accepts log data that indicates Process End.

In step S112, the relationship building unit 120 extracts the operation type and the operation object information from the log data. The operation type is Process End. The operation object is an instruction process, and the target object is end process.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. Then, the relationship building unit 120 adds to the object relationship graph, an edge from the operation object node to the target object node. A relationship according to the operation type is appended to the edge.

### Example 2

In step S111, the reception unit 110 accepts log data that indicates Communication.

In step S112, the relationship building unit 120 extracts the operation type and the operation object information from the log data. The operation type is Communication. The operation object is a communication source process, and the target object is a communication destination process. In a case where each process of the communication source process and the communication destination process is the external process, each process is identified by an external address. The external address is an address that identifies an external device of the monitoring target.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. That is, in a case where the operation object information indicates the external address as an identifier of the operation object or the target object, a node that represents the external process is generated. Then, the relationship building unit 120 adds to the object relationship graph, an edge from the operation object node to the target object node. A relationship according to the operation type is appended to the edge.

### Example 3

In step S111, the reception unit 110 accepts log data that indicates File Manipulation (write).

In step S112, the relationship building unit 120 extracts the operation type and the operation object information from the log data. The operation type is Write File. The operation object is a process, and the target object is a file.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. Then, the relationship building unit 120 adds to the object relationship graph, an edge from the operation object node to the target object node. A relationship according to the operation type is appended to the edge.

### Example 4

In step S111, the reception unit 110 accepts log data that indicates File Manipulation (read).

In step S112, the relationship building unit 120 extracts the operation type and the operation object information from the log data. The operation type is Read File. The operation object is a process, and the target object is a file.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. Then, the relationship building unit 120 adds to the object relationship graph, an edge from the operation object node to the target object node. A relationship according to the operation type is appended to the edge.

### Example 5

In step S111, the reception unit 110 accepts log data that indicates File Manipulation (Change Permission).

In step S112, the relationship building unit 120 extracts the operation type and the operation object information from the log data. The operation type is Change File Permission. The operation object is a process, and the target object is a file.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. Then, the relationship building unit 120 adds to the object relationship graph, an edge from the operation object node to the target object node. A relationship according to the operation type is appended to the edge.

### Example 6

In step S111, the reception unit 110 accepts log data that indicates an OS System Call.

In step S112, the relationship building unit 120 extracts the operation type and the operation object information from the log data. The operation type is a System Call. A type of the System Call, for example, is identified by a name. The operation object is a process, and the target object is a process or a file.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. Then, the relationship building unit 120 adds to the object relationship graph, an edge from the operation object node to the target object node. A relationship according to the operation type is appended to the edge.

### Example 7

In step S111, the reception unit 110 accepts log data that indicates Application Operation.

In step S112, the relationship building unit 120 extracts the operation type and the operation object information from the log data. The operation type is Application Operation. A type of the Application Operation, for example, is identified by a name. The operation object is a process, and the target object is a process or a file.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. Then, the relationship building unit 120 adds to the object relationship graph, an edge from the operation object node to the target object node. A relationship according to the operation type is appended to the edge.

### Example 8

In step S111, the reception unit 110 accepts log data that indicates Security. A specific example of Security is Authentication.

In step S112, the relationship building unit 120 extracts the operation type and the operation object information from the log data. The operation type is Authentication Success, Authentication Failure, or Policy Violation. The operation object is a process, and the target object is a process.

In step S113, the relationship building unit 120 adds an operation object node to the object relationship graph in a case where the operation object node is not in the object relationship graph. The relationship building unit 120 adds a target object node to the object relationship graph in a case where the target object node is not in the object relationship graph. Then, the relationship building unit 120 adds to the object relationship graph, an edge from the operation object node to the target object node. A relationship according to the operation type is appended to the edge.

Effect of Embodiment 1

The polluted range locating apparatus 100 can locate the intrusion route and a polluted part (polluted object).

The polluted range locating apparatus 100 can manage the relationship between the plurality of software objects in a centralized manner with the object relationship graph. As a result, the intrusion route and the polluted part can be promptly located.

By the intrusion route and the polluted part being located, removing the polluted part and taking action for recurrence prevention will be possible.

### Embodiment 2

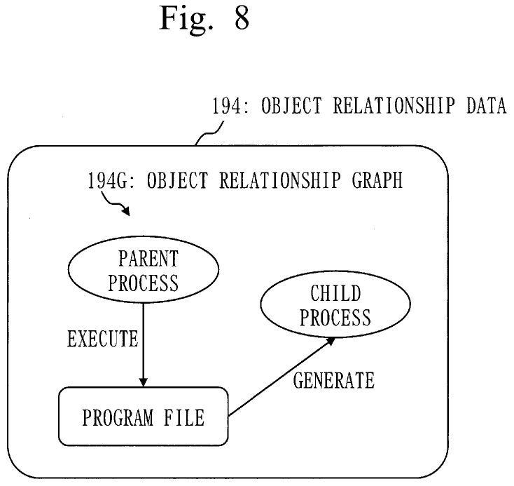

With respect to a form in which object relationship data that includes a relationship between three software objects is generated, differing points from Embodiment 1 will mainly be described based on FIG. 8.

Description of Configuration A configuration of a polluted range locating apparatus 100 is same as the configuration in Embodiment 1 (refer to FIG. 1).

Description of Operation

A polluted range locating method is same as the method in Embodiment 1 (refer to FIG. 2).

The object relationship data that includes the relationship between the three software objects, however, is generated by relationship building (S110).

A procedure of the relationship building (S110) will be described based on FIG. 6.

In step S111, the reception unit 110 receives software operation data.

The software operation data includes an operation type and operation object information. The operation object information indicates the three software objects to be used in software operation identified by the operation type.

In step S112, the relationship building unit 120 extracts the operation type and the operation object information from the software operation data.

In step S113, the relationship building unit 120 updates the object relationship data based on the operation type and the operation object information.

The object relationship data is updated as follows. The object relationship data represents an object relationship graph. The operation object information indicates three software objects: a first object, a second object, and a third object.

The relationship building unit 120 searches the object relationship graph for a node that represents each software object indicated in the operation object information.

The relationship building unit 120 adds a node that is not found to the object relationship graph.

The relationship building unit 120 selects a first object node and a third object node from the object relationship graph. The first object node is a node that represents the first object, and the third object node is a node that represents the third object. The relationship building unit 120 adds an edge that links the two nodes selected to the object relationship graph. Specifically, the relationship building unit 120 adds a directed edge from the first object node to the third object node.

The relationship building unit 120 selects a second object node and the third object node from the object relationship graph. The second object node is a node that represents the second object. The relationship building unit 120 adds an edge that links the two nodes selected to the object relationship graph. Specifically, the relationship building unit 120 adds a directed edge from the third object node to the second object node.

Description of Example

An example of the relationship building (S110) (refer to FIG. 6) will be described based on FIG. 8.

FIG. 8 indicates object relationship data 194. The object relationship data 194 represents an object relationship graph 194G.

In step S111, the reception unit 110 accepts log data that indicates Process Start.

In step S112, the relationship building unit 120 extracts the operation type and the operation object information from the log data. The operation type is Process Start. The first object is a parent process, the second object is a child process, and the third object is a program file.

In step S113, the relationship building unit 120 adds a first object node to the object relationship graph in a case where the first object node is not in the object relationship graph. The relationship building unit 120 adds a second object node to the object relationship graph in a case where the second object node is not in the object relationship graph. The relationship building unit 120 adds a third object node to the object relationship graph in a case where the third object node is not in the object relationship graph. Then, the relationship building unit 120 adds to the object relationship graph, an edge from the first object node to the third object node. Furthermore, the relationship building unit 120 adds to the object relationship graph, an edge from the third object node to the second object node. A relationship according to the operation type is appended to each edge.

Effect of Embodiment 2

The polluted range locating apparatus 100 can manage not only the relationship between two software objects but also the relationship between three software objects.

### Embodiment 3

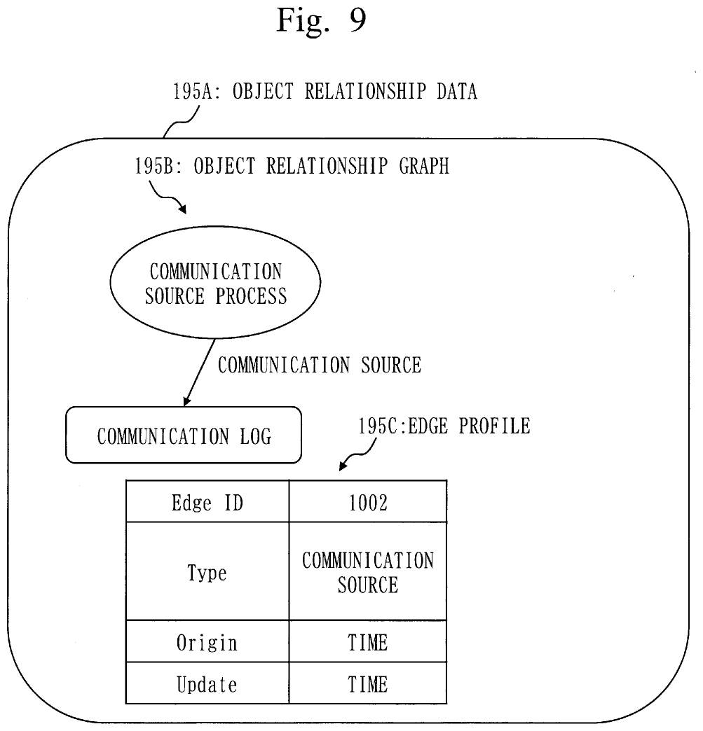

With respect to a form in which a profile is added to each node and each edge in an object relationship graph, differing points from Embodiment 1 will mainly be described based on FIG. 9 to FIG. 11.

Description of Configuration

A configuration of a polluted range locating apparatus 100 is same as the configuration in Embodiment 1 (refer to FIG. 1).

Description of Operation

A polluted range locating method is same as the method in Embodiment 1 (refer to FIG. 2).

A profile, however, is added to each node and each edge in the object relationship graph by relationship building (S110).

A procedure of the relationship building (S110) will be described based on FIG. 6.

In step S111, the reception unit 110 receives software operation data.

In step S112, the relationship building unit 120 extracts an operation type, operation object information, and operation time from the software operation data.

In step S113, the relationship building unit 120 updates object relationship data based on the operation type, the operation object information, and the operation time.

The object relationship data is updated as follows. The object relationship data represents the object relationship graph. The operation object information indicates two software objects: an operation object and a target object.

The relationship building unit 120 searches the object relationship graph for a node that represents each software object indicated in the operation object information.

The relationship building unit 120 updates a profile added to a node that is found. Specifically, the relationship building unit 120 updates update time in the profile to operation time of this time, that is, latest operation time.

The relationship building unit 120 adds a node that is not found to the object relationship graph. Furthermore, the relationship building unit 120 generates a profile for the node that is added, and adds the profile generated to the node that is added. The profile for the node includes a node identifier, a node type, and update time. The node identifier identifies the node. The node type identifies a type of the software object, the software object being represented by the node. Specific examples of the node type are a process, a data file, a program file, and a log file. The update time is operation time of this time, that is, latest operation time.

The relationship building unit 120 selects an operation object node and a target object node from the object relationship graph. The relationship building unit 120 adds an edge that links the two nodes selected to the object relationship graph. Specifically, the relationship building unit 120 adds a directed edge from the operation object node to the target object node. Furthermore, the relationship building unit 120 generates a profile for the edge that is added, and adds the profile generated to the edge that is added. The profile for the edge includes an edge identifier, an edge type, and update time. The edge type identifies a relationship according to the operation type. That is, the edge type identifies a relationship between the two software objects linked by the edge. The update time is operation time of this time, that is, latest operation time.

Description of Example

An example of the relationship building (S110) (refer to FIG. 6) is shown below.

In step S111, the reception unit 110 accepts log data that indicates Communication. The log data may include communication data information. The communication data information indicates communication data, a communication data amount, and the like.

In step S112, the relationship building unit 120 extracts the operation type, the operation object information, and the operation time from the log data. The operation type is Communication. The operation object is a communication source process, and the target object is a communication destination process. In a case where the communication source process or the communication destination process is identified by an external address, the process is an external process. The relationship building unit 120 may extract the communication data information from the log data.

In step S113, the relationship building unit 120 adds an operation object node and a profile for the operation object node to the object relationship graph in a case where the operation object node is not in the object relationship graph. The relationship building unit 120 adds a target object node and a profile for the target object node to the object relationship graph in a case where the target object node is not in the object relationship graph. Each profile that is added includes a node identifier, a node type, generation time, and update time. The node type is a process. Each of the generation time and the update time is same as the operation time extracted from the log data. In a case where the operation object node or the target object node is in the object relationship graph, the relationship building unit 120 updates the update time in the profile for the node to the operation time extracted from the log data.

Furthermore, the relationship building unit 120 adds an edge from the operation object node to the target object node, and an edge profile of the edge to the object relationship graph. A relationship according to the operation type is appended to the edge. The edge profile is a profile for the edge, and includes an edge identifier, an edge type, generation time, and update time. Each of the generation time and the update time is same as the operation time extracted from the log data.

The relationship building unit 120 may include the communication data information in each profile.

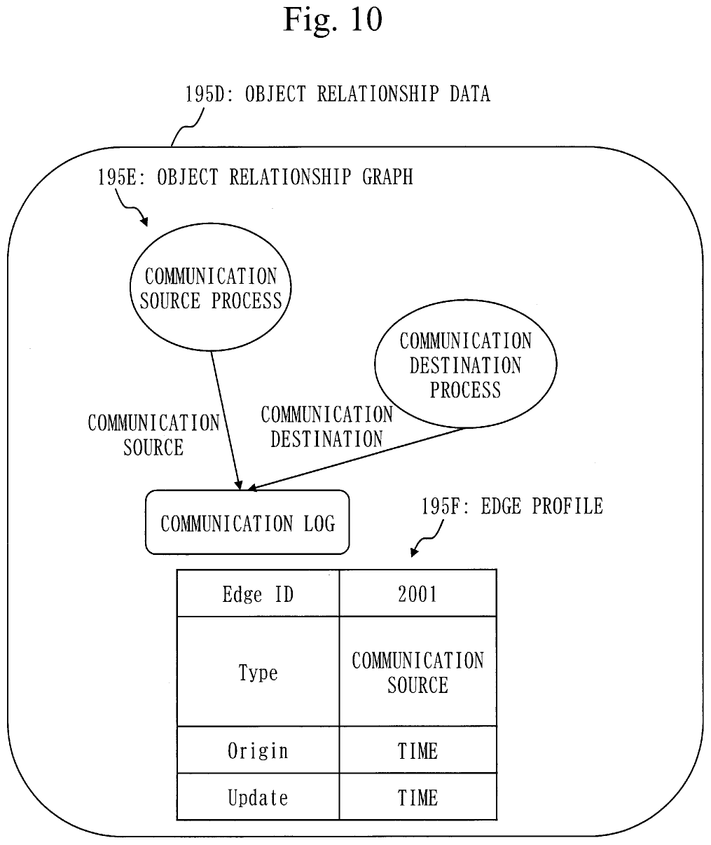

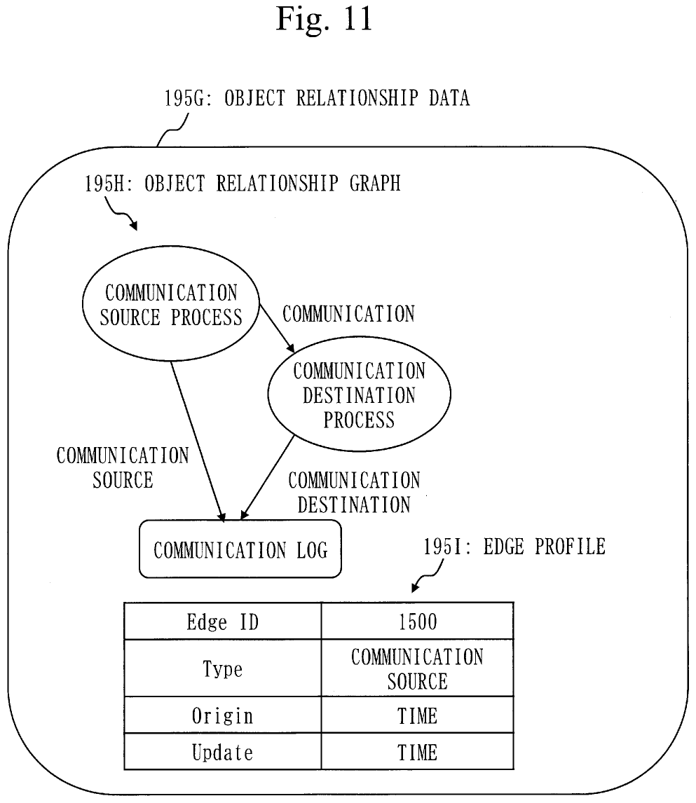

Examples of the object relationship graph including the edge profile are illustrated in FIG. 9, FIG. 10, and FIG. 11. “Edge ID” means an edge identifier. “Type” means an edge type. “Origin” means generation time. “Update” means update time.

FIG. 9 illustrates object relationship data 195A. The object relationship data 195A represents an object relationship graph 195B. The object relationship graph 195B includes an edge profile 195C. The edge profile 195C is a profile for an edge that is from the communication source process to a communication log.

FIG. 10 illustrates object relationship data 195D. The object relationship data 195D represents an object relationship graph 195E. The object relationship graph 195E includes an edge profile 195F. The edge profile 195F is a profile for an edge that is from the communication destination process to the communication log.

FIG. 11 illustrates object relationship data 195G. The object relationship data 195G represents an object relationship graph 195H. The object relationship graph 195H includes an edge profile 1951. The edge profile 1951 is a profile for an edge that is from the communication source process to the communication destination process.

Effect of Embodiment 3

The polluted range locating apparatus 100 can add a profile to each node and each edge. That is, each software object and the relationship between software objects can be managed in more detail.

Each profile has time information. As a result, time series inconsistency is resolved, and the intrusion route and the polluted part are possible to be located with high accuracy.

Supplement to Embodiment 3

Embodiment 2 may be applied to Embodiment 3. That is, as with the object relationship graph in Embodiment 2, the object relationship data in Embodiment 3 may include the relationship between three software objects.

### Embodiment 4

With respect to a form in which an enable flag is added to each node profile, differing points from Embodiment 3 will mainly be described.

Description of Configuration

A configuration of a polluted range locating apparatus 100 is same as the configuration in Embodiment 1 (refer to FIG. 1).

Description of Operation

A polluted range locating method is same as the method in Embodiment 1 (refer to FIG. 2).

A profile, however, is added to each node and each edge in an object relationship graph by relationship building (S110). And, the profile for each node includes the enable flag. The enable flag indicates whether or not a software object is enabled.

A procedure of the relationship building (S110) will be described based on FIG. 6.

In step S111, the reception unit 110 receives software operation data.

In step S112, the relationship building unit 120 extracts an operation type, operation object information, and operation time from the software operation data.

In step S113, the relationship building unit 120 updates object relationship data based on the operation type, the operation object information, and the operation time.

The object relationship data is updated as follows.

The object relationship data represents the object relationship graph. The operation object information indicates two software objects: an operation object and a target object.

The relationship building unit 120 searches the object relationship graph for a node that represents each software object indicated in the operation object information.

The relationship building unit 120 updates a profile added to a node that is found. Specifically, the relationship building unit 120 updates update time in the profile to operation time of this time. Furthermore, the relationship building unit 120 verifies whether or not the operation type identifies object disable operation. The object disable operation is software operation in which the software object is disabled. For example, the object disable operation is Process End, Delete File, or the like. In a case where the operation type identifies the object disable operation, the relationship building unit 120 updates a value of the enable flag in the profile to a disable value. The disable value is a value that means disable.

The relationship building unit 120 adds a node that is not found to the object relationship graph. Furthermore, the relationship building unit 120 generates a profile for the node that is added, and adds the profile generated to the node that is added. The profile for the node includes a node identifier, a node type, update time, and an enable flag. An initial value of the enable flag is an enable value. The enable value is a value that means enable.

The relationship building unit 120 selects an operation object node and a target object node from the object relationship graph. The relationship building unit 120 adds an edge that links the two nodes selected to the object relationship graph. Specifically, the relationship building unit 120 adds a directed edge from the operation object node to the target object node. Furthermore, the relationship building unit 120 generates a profile for the edge that is added, and adds the profile generated to the edge that is added. The profile for the edge includes an edge identifier, an edge type, and update time.

Description of Example

An example of the relationship building (S110) (refer to FIG. 6) is shown below.

In step S111, the reception unit 110 accepts log data that indicates Process End.

In step S112, the relationship building unit 120 extracts the operation type, the operation object information, and the operation time from the log data. The operation type is Process End. The operation object is an instruction process, and the target object is end process.

In step S113, the operation object node is not in the object relationship graph and the target object node is in the object relationship graph. The relationship building unit 120 adds an operation object node and a profile for the operation object node to the object relationship graph. The profile that is added includes a node identifier, a node type, generation time, update time, and an enable flag. The node type is a process. Each of the generation time and the update time is same as the operation time extracted from the log data. The enable flag indicates an enable value. The relationship building unit 120 updates update time in a profile for the target object node to the operation time extracted from the log data. Furthermore, the relationship building unit 120 updates a value of an enable flag in the profile for the target object node to a disable value.

Furthermore, the relationship building unit 120 adds an edge from the operation object node to the target object node, and an edge profile of the edge to the object relationship graph. A relationship according to the operation type is appended to the edge. The edge profile is a profile for the edge, and includes an edge identifier, an edge type, generation time, and update time. Each of the generation time and the update time is same as the operation time extracted from the log data.

Effect of Embodiment 4

The polluted range locating apparatus 100 can have a profile for each node include an enable flag. As a result, the intrusion route and the polluted part are possible to be located with higher accuracy.

Supplement to Embodiments

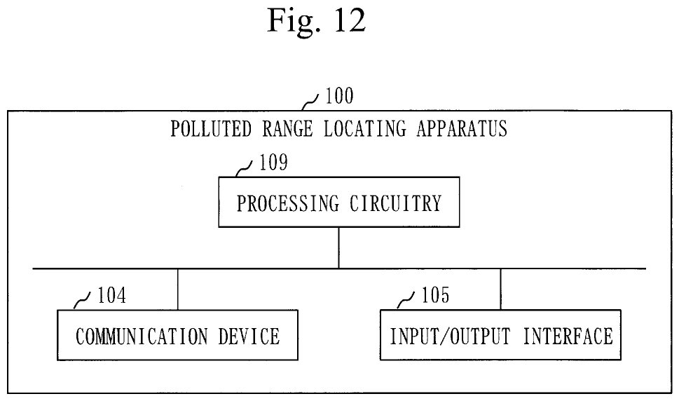

A hardware configuration of the polluted range locating apparatus 100 will be described based on FIG. 12.

The polluted range locating apparatus 100 includes processing circuitry 109.

The processing circuitry 109 is hardware that realizes the reception unit 110, the relationship building unit 120, the polluted range locating unit 130, and the output unit 140.

The processing circuitry 109 may be dedicated hardware or may be the processor 101 that executes a program stored in the memory 102.

In a case where the processing circuitry 109 is dedicated hardware, the processing circuitry 109, for example, is a single circuit, a composite circuit, a programmed processor, a parallel programmed processor, an ASIC, an FPGA, or a combination of these.

ASIC is an abbreviated name for Application Specific Integrated Circuit.

FPGA is an abbreviated name for Field Programmable Gate Array.

The polluted range locating apparatus 100 may include a plurality of processing circuits that replace the processing circuitry 109. The plurality of processing circuits share functions of the processing circuitry 109.

In the processing circuitry 109, a part of the functions may be realized by dedicated hardware and the rest of the functions may be realized by software or firmware.

As described, functions of the polluted range locating apparatus 100 can be realized by hardware, software, firmware, or a combination of these.

Each embodiment is exemplification of a preferred mode, and is not intended to limit the technical scope of the present disclosure. Each embodiment may be carried out partially or may be carried out being combined with a different mode. The procedures described using the flowcharts and the like may be changed as appropriate.

“Unit”, which is an element of the polluted range locating apparatus 100 may be replaced with “process” or “step”.

### REFERENCE SIGNS LIST

100: polluted range locating apparatus; 101: processor; 102: memory; 103: auxiliary storage device; 104: communication device; 105: input/output interface; 109: processing circuitry; 110: reception unit; 120: relationship building unit; 130: polluted range locating unit; 140: output unit; 190: storage unit; 191: object relationship data; 191G: object relationship graph; 192: intrusion route data; 193: polluted object data; 194: object relationship data; 194G: object relationship graph; 195A: object relationship data; 195B: object relationship graph; 195C: edge profile; 195D: object relationship data; 195E: object relationship graph; 195F: edge profile; 195G: object relationship data; 195H: object relationship graph; 1951: edge profile.

1. A polluted range locating apparatus comprising:
processing circuitry to:
based on a plurality of pieces of software operation data, each of which includes an operation type of software operation, operation object information that indicates a plurality of software objects used in the software operation, and operation time when the software operation occurred, generate object relationship data that indicates a relationship between the plurality of software objects, and
based on the object relationship data and alert data that notifies occurrence of a cyberattack, generate polluted range data that indicates a polluted range affected by the cyberattack, wherein
the processing circuitry extracts the operation type and the operation object information from each piece of software operation data, generates as the object relationship data, data that represents an object relationship graph including a plurality of nodes that represent the plurality of software objects indicated in the operation object information extracted, and a directed edge having a direction according to the operation type extracted and that links the plurality of nodes, and adds to each node, a profile that includes a node identifier that identifies the node, a node type that identifies a type of the software object, the software object being represented by the node, and update time that indicates latest operation time.

2. The polluted range locating apparatus according to claim 1, wherein
the processing circuitry adds to each edge, a profile that includes an edge identifier that identifies the edge, an edge type that identifies a relationship between two software objects linked by the edge, and the update time that indicates the latest operation time.

3. The polluted range locating apparatus according to claim 1, wherein
the processing circuitry includes in the profile to be added to each node, an enable flag that indicates whether or not the software object represented by the node is enabled.

4. The polluted range locating apparatus according to claim 1, wherein
the polluted range data includes intrusion route data, and
the processing circuitry extracts from the alert data, abnormal object information that indicates an abnormal object, a software object where the cyberattack was detected, follows each directed edge from a node of the abnormal object to a node of an external process in a reverse direction using the object relationship graph, and generates as the intrusion route data, data that indicates an intrusion route that is a route from the node of the abnormal object to the node of the external process.

5. The polluted range locating apparatus according to claim 4, wherein
the polluted range data includes polluted object data, and
the processing circuitry selects each node positioned on the intrusion route from the object relationship graph, follows each directed edge from each node selected in a forward direction, and generates as the polluted object data, data that indicates the software object represented by each node selected and the software object represented by each node at an end of each directed edge that is followed.

6. The polluted range locating apparatus according to claim 2, wherein
the processing circuitry includes in the profile to be added to each node, an enable flag that indicates whether or not the software object represented by the node is enabled.

7. The polluted range locating apparatus according to claim 2, wherein
the polluted range data includes intrusion route data, and
the processing circuitry extracts from the alert data, abnormal object information that indicates an abnormal object, a software object where the cyberattack was detected, follows each directed edge from a node of the abnormal object to a node of an external process in a reverse direction using the object relationship graph, and generates as the intrusion route data, data that indicates an intrusion route that is a route from the node of the abnormal object to the node of the external process.

8. The polluted range locating apparatus according to claim 3, wherein
the polluted range data includes intrusion route data, and
the processing circuitry extracts from the alert data, abnormal object information that indicates an abnormal object, a software object where the cyberattack was detected, follows each directed edge from a node of the abnormal object to a node of an external process in a reverse direction using the object relationship graph, and generates as the intrusion route data, data that indicates an intrusion route that is a route from the node of the abnormal object to the node of the external process.

9. The polluted range locating apparatus according to claim 6, wherein
the polluted range data includes intrusion route data, and
the processing circuitry extracts from the alert data, abnormal object information that indicates an abnormal object, a software object where the cyberattack was detected, follows each directed edge from a node of the abnormal object to a node of an external process in a reverse direction using the object relationship graph, and generates as the intrusion route data, data that indicates an intrusion route that is a route from the node of the abnormal object to the node of the external process.

10. A non-transitory computer readable medium storing a polluted range locating program for causing a computer to execute:
a relationship building process, based on a plurality of pieces of software operation data, each of which includes an operation type of software operation, operation object information that indicates a plurality of software objects used in the software operation, and operation time when the software operation occurred, to generate object relationship data that indicates a relationship between the plurality of software objects; and
a polluted range locating process, based on the object relationship data and alert data that notifies occurrence of a cyberattack, to generate polluted range data that indicates a polluted range affected by the cyberattack, wherein
the relationship building process extracts the operation type and the operation object information from each piece of software operation data, generates as the object relationship data, data that represents an object relationship graph including a plurality of nodes that represent the plurality of software objects indicated in the operation object information extracted, and a directed edge having a direction according to the operation type extracted and that links the plurality of nodes, and adds to each node, a profile that includes a node identifier that identifies the node, a node type that identifies a type of the software object, the software object being represented by the node, and update time that indicates latest operation time.
